(19) United States
(12) Patent Application Publication
(10) Pub. No.: US 2025/0317047 A1
(43) Pub. Date: Oct. 9, 2025

(54) POWER SYSTEM HAVING SELECTABLE TOPOLOGIES AND ASSOCIATED CONTROL CIRCUIT AND METHOD

(71) Applicant: Chengdu Monolithic Power Systems Co., Ltd., Chengdu (CN)

(72) Inventor: Pengfei Liu, Hangzhou (CN)

(21) Appl. No.: 19/098,763

(22) Filed: Apr. 2, 2025

(30) Foreign Application Priority Data
Apr. 3, 2024 (CN) 202410404333.4

(51) Int. Cl. H02M 1/088; H02M 1/14; H02M 3/00; H02M 3/335; H02M 7/21

(52) U.S. Cl. CPC H02M 1/088; H02M 1/14; H02M 3/01; H02M 3/33571; H02M 3/33592; H02M 7/21

(57) ABSTRACT

A power system having a first secondary switch, a second secondary switch and a third secondary switch is provided. The first secondary switch is configured to be coupled to a first secondary winding of a transformer. The second secondary switch is configured to be coupled to a second secondary winding of the transformer. The third secondary switch is coupled in series with the second secondary switch. The third secondary switch is controlled based on an output voltage of the power system.

### CROSS-REFERENCE TO RELATED APPLICATIONS

This application claims the benefit of and priority to a CN application 202410404333.4, filed on Apr. 3, 2024, which is incorporated herein by reference into the present application.

### TECHNICAL FIELD

The present disclosure relates generally to electronic circuits, and more particularly but not exclusively to power systems and associated control circuits and methods.

### BACKGROUND OF THE INVENTION

For electronic applications such as computer and automotive industry, power system is utilized to perform voltage conversion for providing a suitable voltage to an electronic device. The power system could realize AC to DC voltage conversion and DC to DC voltage conversion.

The power system could adopt different topologies in different applications. LLC topology has been widely used in high-power power systems (e.g., adapters) due to its advantages such as simple structure and low switching loss. The LLC topology is used to convert the voltage from the power grid or other power sources into the suitable voltage for different electronic devices. With the development of society, the growing types and functions of electronic devices result in higher requirements on the supply voltage of the adapters. For example, the range of the supply voltage should be wide enough to meet the voltage requirements of different electronic devices and different operating states. However, the power system having the LLC topology is unable to maintain high efficiency in the entire wide voltage range.

### SUMMARY OF THE INVENTION

According to an embodiment of the present disclosure, a power system is provided. The power system includes a first secondary switch, a second secondary switch and a third secondary switch. The first secondary switch is configured to be coupled to a first secondary winding of a transformer. The second secondary switch is configured to be coupled to a second secondary winding of the transformer. The third secondary switch is coupled in series with the second secondary switch. The third secondary switch is controlled based on an output voltage of the power system.

According to another embodiment of the present disclosure, a control circuit for a voltage conversion circuit is provided. The voltage conversion circuit includes a transformer, a first secondary switch coupled to a first secondary winding of the transformer, and a bidirectional switch coupled to a second secondary winding of the transformer. The control circuit includes a mode determining circuit. The mode determining circuit provides a mode indicating signal based on a feedback signal indicating an output voltage of voltage conversion circuit. The control circuit provides a bidirectional switch control signal to control the bidirectional switch of the voltage conversion circuit based on the mode indicating signal.

According to yet another embodiment of the present disclosure, a method for controlling a voltage conversion circuit is provided. The voltage conversion circuit includes a transformer, a first secondary switch coupled to a first secondary winding of the transformer, a second secondary switch coupled to a second secondary winding of the transformer, and a third secondary switch coupled in series with the second secondary switch. The method includes a following action. A secondary switch control signal is provided to control the third secondary switch based on a feedback signal indicating an output voltage of the voltage conversion circuit. When the feedback signal is within a designated voltage range, the third secondary switch is turned on. When the feedback signal is out of the designated voltage range, the third secondary switch is turned off.

### BRIEF DESCRIPTION OF THE DRAWINGS

The present disclosure can be further understood with reference to the following detailed description and appended drawings, where like elements are provided with like reference numerals. These drawings are only for illustration purpose, thus may only show part of the devices and are not necessarily drawn to scale.

FIG. 1 schematically shows a voltage conversion circuit.

FIG. 2 schematically shows a power system in accordance with one embodiment of the present disclosure.

FIG. 3 schematically show a power system in accordance with one embodiment of the present disclosure.

FIG. 4 schematically shows a power system in accordance with one embodiment of the present disclosure.

FIG. 5 schematically shows a power system in accordance with one embodiment of the present disclosure.

FIG. 6 schematically shows a power system in accordance with one embodiment of the present disclosure.

FIG. 7 schematically shows a power system in accordance with one embodiment of the present disclosure.

FIG. 8 schematically shows a power system in accordance with one embodiment of the present disclosure.

FIG. 9 shows a flowchart of a method for controlling a voltage conversion circuit in accordance with one embodiment of the present disclosure.

FIG. 10 shows a flowchart of a method for controlling a voltage conversion circuit in accordance with one embodiment of the present disclosure.

### DETAILED DESCRIPTION

Various embodiments of the present disclosure will now be described. In the following description, some specific details, such as example circuits and example values for these circuit components, are included to provide a thorough understanding of embodiments. One skilled in the relevant art will recognize, however, that the present disclosure can be practiced without one or more specific details, or with other methods, components, materials, etc. In other instances, well-known structures, materials, processes or operations are not shown or described in detail to avoid obscuring aspects of the present disclosure.

Throughout the specification and claims, the phrases “in one embodiment”, “in some embodiments”, “in one implementation”, and “in some implementations” as used includes both combinations and sub-combinations of various features described herein as well as variations and modifications thereof. These phrases used herein do not necessarily refer to the same embodiment, although it may. Those skilled in the art should understand that the meanings of the terms identified above do not necessarily limit the terms, but merely provide illustrative examples for the terms. It is noted that when an element is “connected to” or “coupled to” the other element, it means that the element is directly connected to or coupled to the other element, or indirectly connected to or coupled to the other element via another element. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

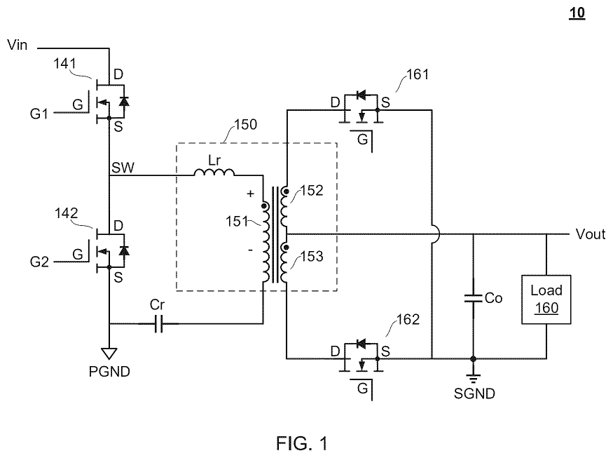

FIG. 1 schematically shows a voltage conversion circuit 10. As shown in FIG. 1, the voltage conversion circuit 10 has an LLC topology including a transformer 150, a first primary switch 141, a second primary switch 142, a resonant capacitor Cr, a first secondary switch 161, a second secondary switch 162 and an output capacitor Co. The first primary switch 141 and the second primary switch 142 are coupled in series between an input terminal and a primary ground PGND. The first primary switch 141 and the second primary switch 142 are turned on alternately under the control of a first control signal G1 and a second control signal G2, respectively, to convert an input voltage Vin of the voltage conversion circuit 10 into an output voltage Vout for powering a load 160. The transformer 150 includes a primary winding 151, a first secondary winding 152 and a second secondary winding 153. A resonant inductor Lr is the leakage inductance of the primary winding 151 of the transformer 150. The first secondary switch 161 is coupled between the first secondary winding 152 and a secondary ground SGND, and the second secondary switch 162 is coupled between the second secondary winding 153 and the secondary ground SGND. The first secondary switch 161 and the second secondary switch 162 are turned on and off alternately to transfer energy to the load 160.

The voltage conversion circuit 10 with the LLC topology has the highest operating efficiency when the output voltage Vout is within a designated range, for example, when the output voltage Vout is close to the rated voltage. However, for applications having a wider range of the output voltage Vout, for instance, the output voltage Vout of an adapter may vary from 5V to 48V or even wider, the efficiency and other requirements of the LLC converter such as output ripple and noise are compromised. For example, when the voltage conversion circuit 10 with the LLC topology is designed to have the relatively high operating efficiency when the output voltage Vout is equal to the highest output voltage (e.g., 48V), the operating efficiency of the LLC topology would decrease dramatically when the output voltage Vout decreases. When the output voltage Vout decreases to 5V, the operating efficiency of the voltage conversion circuit 10 with the LLC topology is relatively low. Furthermore, due to the voltage conversion circuit 10 still needs to operate in a burst mode when the output current is large, resulting in large output ripple and noise in addition to low operating efficiency.

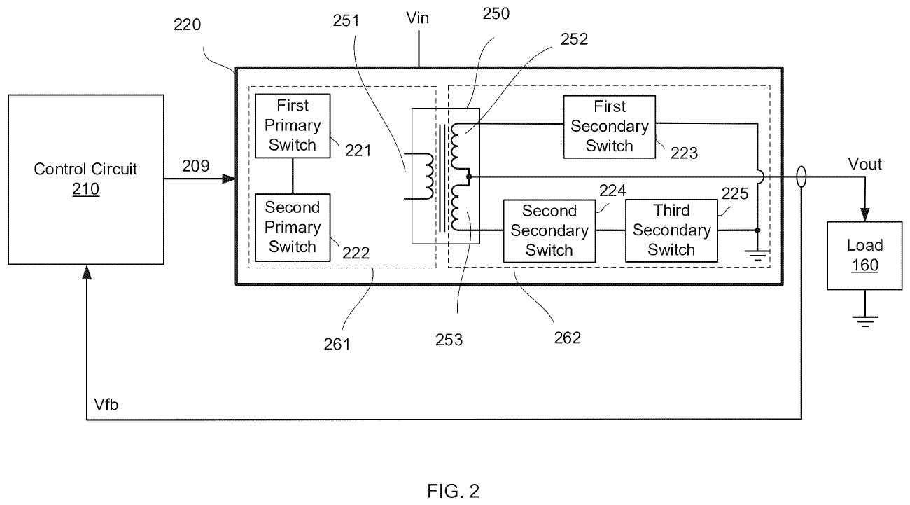

FIG. 2 schematically shows a power system 20 in accordance with one embodiment of the present disclosure. As shown in FIG. 2, the power system 20 includes a voltage conversion circuit 220 and a control circuit 210. The control circuit 210 is configured to receive a feedback signal Vfb indicating the output voltage Vout of the power system 20, and to provide a switching control signal 209 for controlling the voltage conversion circuit 220. The voltage conversion circuit 220 is configured to receive the switching control signal 209, and to convert the input voltage Vin into the output voltage Vout to power the load 160.

In the embodiment of FIG. 2, the voltage conversion circuit 220 includes a first primary switch 221, a second primary switch 222, a transformer 250, a first secondary switch 223, a second secondary switch 224 and a third secondary switch 225. The first primary switch 221 is coupled in series with the second primary switch 222. The transformer 250 includes a primary winding 251, a first secondary winding 252 and a second secondary winding 253. A primary circuit 261 includes the first primary switch 221, the second primary switch 222, the primary winding 251 and other circuit components electrically coupled to the primary winding 251. The first secondary switch 223 is coupled to the first secondary winding 252, and the second secondary switch 224 is coupled to the second secondary winding 253. The third secondary switch 225 is coupled in series with the second secondary switch 224. A secondary circuit 262 includes the first secondary switch 223, the second secondary switch 224, the third secondary switch 225, the first secondary winding 252, the second secondary winding 253 and other circuit components electrically coupled to the first secondary winding 252 and the second secondary winding 253.

In the embodiment of FIG. 2, the third secondary switch 225 is turned on and off based on the output voltage Vout of the power system 20. For example, when the value of the output voltage Vout is within a designated range, the third secondary switch 225 is turned on; and when the value of the output voltage Vout is out of the designated range, the third secondary switch 225 is turned off. The designated range could be a designated voltage interval or a range greater than a designated voltage value. For example, the designated range is from 40V to 48V. In another example, the designated range is greater than 40V. When the third secondary switch 225 is turned on, the voltage conversion circuit 220 operates the same as an LLC topology. The first secondary switch 223 and the second secondary switch 224 are turned on alternately to transfer the energy of the first secondary winding 252 and the second secondary winding 253 to the load 160. When the third secondary switch 225 is turned off, the voltage conversion circuit 220 operates the same as an asymmetrical half-bridge flyback converter topology. The second secondary winding 253 does not transfer the energy to the load 160. The first secondary switch 223 is turned on and off to transfer the energy of the first secondary winding 252 to the load 160.

In the embodiment of FIG. 2, the switching control signal 209 provided by the control circuit 210 may include a primary switch control signal and a secondary switch control signal. The primary switch control signal in configured to control the first primary switch 221 and the second primary switch 222. The secondary switch control signal is configured to control the third secondary switch 225. The switching control signal 209 may further include a control signal for controlling the first secondary switch 223 and the second secondary switch 224.

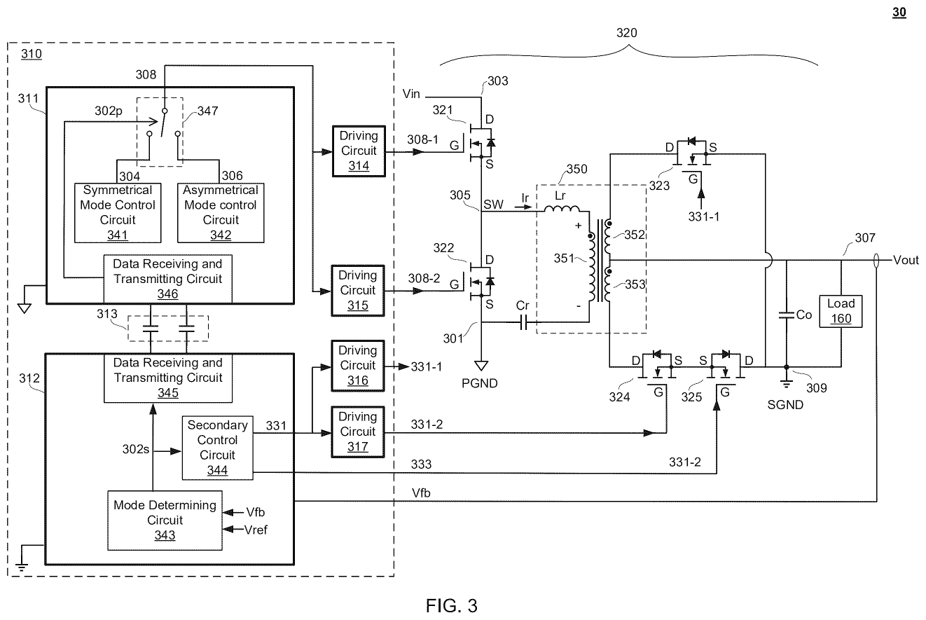

FIG. 3 schematically show a power system 30 in accordance with one embodiment of the present disclosure. As shown in FIG. 3, the power system 30 includes a voltage conversion circuit 320 and a control circuit 310. The control circuit 310 is configured to receive the feedback signal Vfb indicating the output voltage Vout of the power system 30, and to provide a first primary switch control signal 308-1, a second primary switch control signal 308-2, a first secondary switch control signal 331-1, a second secondary switch control signal 331-2 and a third secondary switch control signal 333 for controlling the voltage conversion circuit 320. The voltage conversion circuit 320 is configured to receive the first primary switch control signal 308-1, the second primary switch control signal 308-2, the first secondary switch control signal 331-1, the second secondary switch control signal 331-2 and the third secondary switch control signal 333, and to convert the input voltage Vin into the output voltage Vout to power the load 160.

In the embodiment of FIG. 3, the voltage conversion voltage 320 has an input terminal 303 configured to receive the input voltage Vin, a primary ground terminal 301 coupled to the primary ground PGND and an output terminal 307 configured to provide the output voltage Vout to the load 160. The voltage conversion circuit 320 includes a first primary switch 321, a second primary switch 322, a resonant capacitor Cr, a transformer 350, a first secondary switch 323, a second secondary switch 324 and a third secondary switch 325. The transformer 350 includes a primary winding 351, a first secondary winding 352 and a second secondary winding 353. The first primary switch 321 and the second primary switch 322 are coupled in series between the input terminal 303 and the primary ground terminal 301. A connection point 305 (i.e., a switching terminal SW) formed by the first primary switch 321 and the second primary switch 322 is coupled to the primary winding 351 of the transformer 350. Meanwhile, the resonant capacitor Cr is coupled in series with the primary winding 351 of the transformer 350. In the embodiment of FIG. 3, the resonant capacitor Cr and the primary winding 351 of the transformer 350 are coupled in series between the switching terminal SW and the primary ground terminal 301.

The first secondary switch 323 is coupled to the first secondary winding 352. The second secondary switch 324 is coupled to the second secondary winding 353. The third secondary switch 325 is coupled in series with the second secondary switch 324. Specifically, in the embodiment of FIG. 3, the first secondary switch 323 and the first secondary winding 352 are coupled in series between the output terminal 307 and a secondary ground terminal 309. The second secondary switch 324, the third secondary switch 325 and the second secondary winding 353 are coupled in series between the output terminal 307 and the secondary ground terminal 309.

In the embodiment of FIG. 3, the third secondary switch 325 is controlled by the third secondary switch control signal 333 based on the output voltage Vout of the power system 30. When the value of the output voltage Vout is within the designated range, the third secondary switch 325 is turned on under the control of the third secondary switch control signal 333. When the value of the output voltage Vout is out of the designated range, the third secondary switch 325 is turned off under the control of the third secondary switch control signal 333. When the third secondary switch 325 is turned on, the voltage conversion circuit 320 operates the same as the LLC topology. The first secondary switch 323 and the second secondary switch 324 are turned on alternately under the control of the secondary switch control signals 331-1 and 331-2, respectively, to transfer the energy of the first secondary winding 352 and the second secondary winding 353 to the load 160. When the third secondary switch 325 is turned off, the voltage conversion circuit 320 operates the same as the asymmetrical half-bridge flyback converter topology, the second secondary winding 353 does not transfer the energy to the load 160. The first secondary switch 323 is turned on and off to transfer the energy of the first secondary winding 352 to the load 160.

In the embodiment of FIG. 3, the control circuit 310 includes a mode determining circuit 343, a symmetrical mode control circuit 341 and an asymmetrical mode control circuit 342. The mode determining circuit 343 is integrated in a secondary control integrated circuit 312, and the symmetrical mode control circuit 341 and the asymmetrical mode control circuit 342 are integrated in a primary control integrated circuit 311. The mode determining circuit 343 is configured to receive the feedback signal Vfb indicating the output voltage Vout, and to provide a mode indicating signal 302s based on the feedback signal Vfb. In the embodiment of FIG. 3, the mode determining circuit 343 is configured to compare the feedback signal Vfb with a reference voltage Vref. When the feedback signal Vfb is greater than the reference voltage Vref, the mode indicating signal 302s indicates that the voltage conversion circuit 320 operates in a symmetrical mode; otherwise, the mode indicating signal 302s indicates that the voltage conversion circuit 320 operates in an asymmetrical mode.

Different states of the mode indicating signal 302s may indicate different operating modes of the voltage conversion circuit 320. For example, the mode indicating signals 302s may include different voltage levels (e.g., a high voltage level and a low voltage level) to indicate different operating modes. In some embodiments, the mode indicating signals 302s may be data with multiple digits, and different data values indicate different operating modes. It should be appreciated that, in other embodiments, the reference voltage Vref may include a plurality of voltage values. The mode determining circuit 343 is configured to receive the reference voltage Vref and the feedback signal Vfb, and to indicate different operating modes based on the voltage interval in which the value of the feedback signal Vfb is located.

In the embodiment of FIG. 3, an isolation communication circuit 313 is configured to provide communication between the primary control integrated circuit 311 and the secondary control integrated circuit 312. The secondary control integrated circuit 312 further includes a data receiving and transmitting circuit 345. The data receiving and transmitting circuit 345 is configured to receive the mode indicating signal 302s, and to provide the mode indicating signal 302s to the isolation communication circuit 313. The primary control integrated circuit 311 further includes a data receiving and transmitting circuit 346. The data receiving and transmitting circuit 346 is configured to receive a signal from the isolation communication circuit 313, and to provide a mode indicating signal 302p based on the received signal. The mode indicating signal 302p includes information of the mode indicating signal 302s, that is, the mode indicating signal 302p also could indicate that the voltage conversion circuit 320 operates in the symmetrical mode or the asymmetrical mode. The signal forms and voltage levels of the mode indicating signal 302p and the mode indicating signal 302s may be the same or different, which are determined by the isolation communication circuit 313 and the data receiving and transmitting circuits 345 and 346. In the embodiment of FIG. 3, the isolation communication circuit 313 includes a capacitor, i.e., the isolation communication circuit 313 is a capacitive isolation circuit. It should be appreciated that other isolation circuits, such as a magnetic isolation circuit and an optocoupler isolation circuit, may also be applied to the embodiment of the disclosure.

The data receiving and transmitting circuit 345 is configured to convert the mode indicating signal 302s into a differential signal, and to provide the differential signal to the isolation communication circuit 313. The isolation communication circuit 313 is configured to provide the differential signal to the data receiving and transmitting circuit 346. The data receiving and transmitting circuit 346 is configured to convert the differential signal into the mode indicating signal 302p. It should be appreciated that, in some embodiments, the mode indicating signal 302s may be a differential signal. In this case, the data receiving and transmitting circuit 345 may be omitted or perform other forms of data conversion on the mode indicating signals 302s (e.g., the voltage level of the mode indicating signal 302s is converted). Similarly, the mode indicating signal 302p may also be a differential signal. In this case, the data receiving and transmitting circuit 346 may be omitted or perform other forms of data conversion on the mode indicating signal 302p (e.g., the voltage level of the mode indicating signal 302p is converted).

It should be understood that the data receiving and transmitting circuits 345 and 346 and the isolation communication circuit 313 are used to provide the mode indicating signals 302s from the secondary control integrated circuit 312 to the primary control integrated circuit 311 for controlling the primary control integrated circuit 311 to provide different control signals. Therefore, based on the different control signals, the voltage conversion circuit 320 operates in different operating modes, i.e., the symmetrical mode or the asymmetrical mode. It should be appreciated that using the differential signal to transmit data could improve the efficiency and reliability of data transmission. Other data transmission forms and other circuits that could perform data transmission between isolated circuits may also be applied to the embodiments of the present disclosure.

The symmetrical mode control circuit 341 is configured to provide a symmetrical mode control signal 304 for controlling the first primary switch 321 and the second primary switch 322. The asymmetrical mode control circuit 342 is configured to provide the asymmetrical mode control signal 306 for controlling the first primary switch 321 and the second primary switch 322. Based on the mode indicating signal 302p, the symmetrical mode control signal 304 or the asymmetrical mode control signal 306 is selected as the primary switch control signal 308 for controlling the first primary switch 321 and the second primary switch 322. In the embodiment of FIG. 3, a selecting circuit 347 is configured to receive the symmetrical mode control signal 304, the asymmetrical mode control signal 306 and the mode indicating signal 302p, and to provide the symmetrical mode control signal 304 or the asymmetrical mode control signal 306 as the primary switch control signal 308 based on the mode indicating signal 302p. It should be appreciated that the selecting circuit 347 of FIG. 3 is only for illustration purpose, other circuits that could realize the selection function may be used in the embodiment of the present disclosure.

In the embodiment of FIG. 3, the symmetrical mode control circuit 341 may be implemented by control circuits of the LLC topology circuit. Typically, the symmetrical mode control signal 304 provided by the symmetrical mode control circuit 341 has a duty cycle of 50%. Therefore, in one switching period, each of the first primary switch 321 and the second primary switch 322 is turned on for the switching period of 50%. The switching period is also referred to as the operating period of the voltage conversion circuit 320. In one embodiment, the switching period refers to a duration from the time when the first primary switch 321 or the second primary switch 322 is turned on to the next time when the first primary switch 321 or the second primary switch 322 is turned on. In another embodiment, the switching period refers to a duration from the time when the first primary switch 321 or the second primary switch 322 is turned off to the next time when the first primary switch 321 or the second primary switch 322 is turned off.

It should be understood that the duty cycle of 50% and the switching period of 50% are illustrated under the conditional that a dead time is negligible. The dead time is used to avoid the shoot-through of the first primary switch 321 and the second primary switch 322. When the dead time is considered, the duty cycle of the symmetrical mode control signal 304 may be slightly less than 50%. Similarly, the on-periods of the first primary switch 321 and the second primary switch 322 are slightly less than the switching period of 50%. However, since the dead time is almost negligible compared to the switching period, the dead time is not specifically mentioned in the present disclosure. Furthermore, in some applications, the duty cycle of the first primary switch 321 is not always consistent with the duty cycle of the second primary switch 322.

The asymmetrical mode control circuit 342 may be implemented by control circuits of the asymmetrical half-bridge flyback converter. The asymmetrical mode control signal 306 provided by the asymmetrical mode control circuit 342 is configured to control the first primary switch 321 and the second primary switch 322 based on the input and output of the power system 30. Generally, suppose the input of the power system 30 is fixed, in one switching period, when the on-period of the first primary switch 321 is longer, the output power is higher.

In the embodiment of FIG. 3, the control circuit 310 further includes a driving circuit 314 and a driving circuit 315. The driving circuit 314 is configured to receive the primary switch control signal 308, and to convert the primary switch control signal 308 into the first primary switch control signal 308-1 for controlling the first primary switch 321. The driving circuit 315 is configured to receive the primary switch control signal 308, and to convert the primary switch control signal 308 into the second primary switch control signal 308-2 for controlling the second primary switch 322. In one embodiment, the first primary switch control signal 308-1 has the opposite phase with the second primary switch control signal 308-2, thus the first primary switch 321 is turned on and off alternately with the second primary switch 322.

It should be understood that under the control of the first primary switch control signal 308-1 and the second primary switch control signal 308-2, there is a dead time to avoid the shoot-through of the first primary switch 321 and the second primary switch 322. In other words, there is a time that the first primary switch 321 and the second primary switch 322 are both turned off. In one embodiment, the driving circuit 314 and the driving circuit 315 may be integrated independently in different integrated circuits (ICs). In another embodiment, the driving circuit 314 and the driving circuit 315 may be integrated in the same IC. In yet another embodiment, some or all of the driving circuit 314, the driving circuit 315 and the primary control integrated circuit 311 may be integrated in the same IC.

In the embodiment of FIG. 3, the secondary control integrated circuit 312 further includes a secondary control circuit 344. The secondary control circuit 344 is configured to receive the mode indicating signal 302s, and to provide the third secondary switch control signal 333 for controlling the third secondary switch 325 based on the mode indicating signal 302s. In some embodiments, the mode indicating signal 302s is a signal having a high voltage level and a low voltage level, which is directly used as the third secondary switch control signal 333 for controlling the third secondary switch 325.

The secondary control circuit 344 is further configured to provide the secondary switch control signal 331 for controlling the first secondary switch 323 and the second secondary switch 324. In one embodiment, when the third secondary switch 325 is turned on, the voltage conversion circuit 320 operates in the symmetrical mode. Each of the first secondary switch 323 and the second secondary switch 324 is turned on and off with the duty cycle of 50%. At this time, the voltage conversion circuit 320 operates the same as the LLC topology. That is, when the first primary switch 321 is turned on and the second primary switch 322 is turned off, the first secondary switch 323 is turned on and the second secondary switch 324 is turned off; and when the first primary switch 321 is turned off and the second primary switch 322 is turned on, the first secondary switch 323 is turned off and the second secondary switch 324 is turned on. Typically, each of the switches 321-324 is turned on and off with the duty cycle of 50% during one operating period of the voltage conversion circuit 320. In other words, during one operating period of the voltage conversion circuit 320, the on-period of the first primary switch 321 is same as the on-period of the second primary switch 322, and the on-period of the first secondary switch 323 is same as the on-period of the second secondary switch 324.

It should be understood that, in some operating conditions, the on and off states of the secondary switches may not be consistent with the on-off states of the primary switches. For example, when the voltage conversion circuit 320 operates above the resonant frequency (i.e., the switching frequency of the voltage conversion circuit 320 is higher than the resonant frequency), after the second primary switch 322 is turned off, the second secondary switch 324 keeps on and the current still flows through the second secondary switch 324.

In one embodiment, the control circuit 310 further includes driving circuits 316 and 317. The driving circuit 316 is configured to generate the first secondary switch control signal 331-1 based on the secondary switch control signal 331. The driving circuit 317 is configured to generate the second secondary switch control signal 331-2 based on the secondary switch control signal 331. The first secondary switch control signal 331-1 has the opposite phase with the second secondary switch control signal 331-2 (i.e., the phase difference between the two is 180°). The first secondary switch control signal 331-1 and the second secondary switch control signal 331-2 are configured to control the first secondary switch 323 and the second secondary switch 324, respectively. In some embodiments, the first secondary switch control signal 331-1 is in phase with the secondary switch control signal 331, and the second secondary switch control signal 331-2 has the opposite phase with the secondary switch control signal 331. In other embodiments, the first secondary switch control signal 331-1 has the opposite phase with the secondary switch control signal 331, and the second secondary switch control signal 331-2 is in phase with the secondary switch control signal 331.

In one embodiment, when the third secondary switch 325 is turned off, the voltage conversion circuit 320 operates in the asymmetrical mode, and the second secondary switch 324 and the second secondary winding 353 are inoperable. The first secondary switch 323 operates under the control of the first secondary switch control signal 331-1. In one embodiment, when the first primary switch 321 is turned on and the second primary switch 322 is turned off, the first secondary switch 323 is turned off; and when the first primary switch 321 is turned off and the second primary switch 322 is turned on, the first secondary switch 323 is turned on. In one embodiment, when the third secondary switch 325 is turned off, the first secondary switch control signal 331-1 is substantially consistent with the secondary switch control signal 331. It is to be understood that “substantially” is a term of art, and is meant to convey the principle that relationship such simultaneity or perfect synchronization cannot be met with exactness, but only within the tolerances of the technology available to a practitioner of the art under discussion. In one embodiment, the driving circuit 316 and the driving circuit 317 may be integrated independently in different ICs. In another embodiment, the driving circuit 316 and the driving circuit 317 may be integrated in the same IC. In yet another embodiment, some or all of the driving circuit 316, the driving circuit 317 and the secondary control integrated circuit 312 may be integrated in the same IC.

In the embodiment of FIG. 3, the first primary switch 321, the second primary switch 322, the first secondary switch 323, the second secondary switch 324 and the third secondary switch 325 all include N-type Metal Oxide Semiconductor Field Effect Transistor (MOSFET) device. The source S of the first primary switch 321 is coupled to the drain D of the second primary switch 322. The drain D of the first secondary switch 323 is coupled to the first secondary winding 352, and the source S of the first secondary switch 323 is coupled to the secondary ground terminal 309. The drain D of the second secondary switch 324 is coupled to the second secondary winding 353, and the source S of the second secondary switch 324 is coupled to the source S of the third secondary switch 325. The drain D of the third secondary switch 325 is coupled to the secondary ground terminal 309.

In the embodiment of FIG. 3, the source S of the second secondary switch 324 is coupled to the source S of the third secondary switch 325 such that the body diode of the second secondary switch 324 is coupled reversely to the body diode of the third secondary switch 325. Therefore, when the voltage conversion circuit 320 operates in the asymmetrical mode, the current in the loop of the second secondary winding 353 could be effectively blocked. In other words, the body diodes of the second secondary switch 324 and the third secondary switch 325 are connected in opposite directions. For example, the anode of the body diode of the second secondary switch 324 is coupled to the anode of the body diode of the third secondary switch 325. In other embodiments, the drain D of the second secondary switch 324 is coupled to the drain D of the third secondary switch 325 such that the cathode of the body diode of the second secondary switch 324 is coupled to the cathode of the body diode of the third secondary switch 325.

In some embodiments, the first primary switch 321, the second primary switch 322, the first secondary switch 323, the second secondary switch 324 and the third secondary switch 325 may also include other types of switching devices, such as gallium nitride (GaN) devices and silicon carbide (SiC) devices. In one embodiment, the first secondary switch 323 and the second secondary switch 324 are implemented by diodes. In this case, when the third secondary switch 325 employs the N-type MOSFET device as shown in FIG. 3, the direction of the body diode of the third secondary switch 325 should be opposite to the direction of the body diode of the second secondary switch 324 to effectively realize the blocking of the current.

In some embodiments, the primary control integrated circuit 311 and the secondary control integrated circuit 312 are different ICs for controlling the primary circuit and the secondary circuit of the voltage conversion circuit 320, respectively. In some embodiments, the primary control integrated circuit 311 and the secondary control integrated circuit 312 may be integrated in the same package to realize the control of the voltage conversion circuit 320.

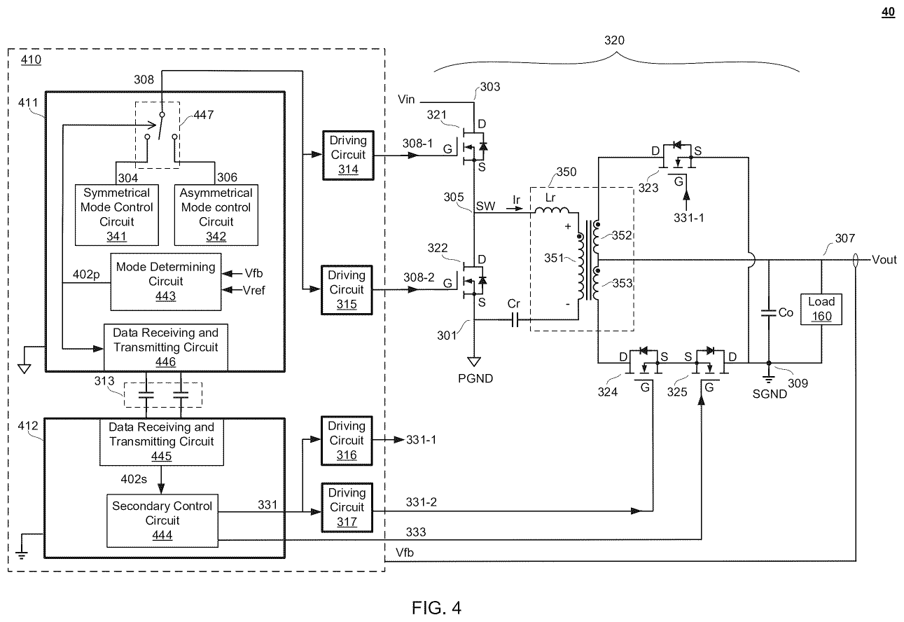

FIG. 4 schematically shows a power system 40 in accordance with one embodiment of the present disclosure. As shown in FIG. 4, the power system 40 includes the voltage conversion circuit 320 and a control circuit 410. The control circuit 410 is configured to receive the feedback signal Vfb indicating the output voltage Vout of the power system 40, and to provide the first primary switch control signal 308-1, the second primary switch control signal 308-2, the first secondary switch control signal 331-1, the second secondary switch control signal 331-2 and the third secondary switch control signal 333 for controlling the voltage conversion circuit 320. The voltage conversion circuit 320 is configured to receive the first primary switch control signal 308-1, the second primary switch control signal 308-2, the first secondary switch control signal 331-1, the second secondary switch control signal 331-2 and the third secondary switch control signal 333, and to convert the input voltage Vin to the output voltage Vout to power the load 160.

In the embodiment of FIG. 4, the third secondary switch 325 is controlled by the third secondary switch control signal 333 based on the output voltage Vout of the power system 40. When the output voltage Vout is greater than the designated value, the third secondary switch 325 is turned on under the control of the third secondary switch control signal 333. When the output voltage Vout is less than the designated value, the third secondary switch 325 is turned off under the control of the third secondary switch control signal 333. When the third secondary switch 325 is turned on, the voltage conversion circuit 320 operates the same as the LLC topology. The first secondary switch 323 and the second secondary switch 324 are turned on alternately under the control of the secondary switch control signals 331-1 and 331-2, respectively, such that the energy of the first secondary winding 352 and the second secondary winding 353 is transferred to the load 160. When the third secondary switch 325 is turned off, the voltage conversion circuit 320 operates the same as the asymmetrical half-bridge flyback converter topology. The second secondary winding 353 does not transfer the energy to the load 160. The first secondary switch 323 is turned on and off, such that the energy of the first secondary winding 352 is transferred to the load 160.

In the embodiment of FIG. 4, the control circuit 410 includes a mode determining circuit 443, the symmetrical mode control circuit 341 and the asymmetrical mode control circuit 342. The mode determining circuit 443, the symmetrical mode control circuit 341 and the asymmetrical mode control circuit 342 are integrated into a primary control integrated circuit 411.

The mode determining circuit 443 is configured to receive the feedback signal Vfb indicating the output voltage Vout, and to provide a mode indicating signal 402p based on the feedback signal Vfb. In the embodiment of FIG. 4, the mode determining circuit 443 is configured to compare the feedback signal Vfb with the reference voltage Vref, and to provide the mode indicating signal 402p to indicate that the voltage conversion circuit 320 operates in the symmetrical mode or the asymmetrical mode based on the comparison result. Different states of the mode indicating signal 402p indicates different operating modes of the voltage conversion circuit 320. For example, the mode indicating signals 402p may include a high voltage level and a low voltage level to indicate different operating modes. In some embodiments, the mode indicating signals 402p may be data with multiple digits, and different data values indicate different operating modes.

In the embodiment of FIG. 4, the isolation communication circuit 313 is configured to provide communication between the primary control integrated circuit 411 and a secondary control integrated circuit 412. The primary control integrated circuit 411 further includes a data receiving and transmitting circuit 446. The data receiving and transmitting circuit 446 is configured to receive the mode indicating signal 402p, and to provide the mode indicating signal 402p to the isolation communication circuit 313. The secondary control integrated circuit 412 further includes a data receiving and transmitting circuit 445. The data receiving and transmitting circuit 445 is configured to receive the signal from the isolation communication circuit 313, and to provide a mode indicating signal 402s based on the received signal. The mode indicating signal 402s includes information of the mode indicating signal 402p, that is, the mode indicating signal 402s also could indicate that the voltage conversion circuit 320 operates in the symmetrical mode or the asymmetrical mode. The signal forms and voltage levels of the mode indicating signal 402s and the mode indicating signal 402p may be the same or different, which are determined by the isolation communication circuit 313 and the data receiving and transmitting circuits 445 and 446. In the embodiment of FIG. 4, the isolation communication circuit 313 includes the capacitor, i.e., the isolation communication circuit 313 is the capacitive isolation circuit. It should be appreciated that other isolation circuits, such as the magnetic isolation circuit and the optocoupler isolation circuit, may also be applied to the embodiment of the disclosure.

The data receiving and transmitting circuit 446 is configured to convert the mode indicating signal 402p into a differential signal. The differential signal is provided to the isolation communication circuit 313. The isolation communication circuit 313 is configured to provide the differential signal to the data receiving and transmitting circuit 445. The data receiving and transmitting circuit 445 is configured to convert the differential signal into the mode indicating signal 402s. It should be appreciated that, in some embodiments, the mode indicating signal 402p may be the differential signal. In this case, the data receiving and transmitting circuit 446 may be omitted or perform other forms of data conversion on the mode indicating signals 402p (e.g., the voltage level of the mode indicating signal 402p is converted). Similarly, the mode indicating signal 402s may be the differential signal. In this case, the data receiving and transmitting circuit 445 may be omitted or perform other forms of data conversion on the mode indicating signal 402s (e.g., the voltage level of the mode indicating signal 402s is converted).

It should be understood that the data receiving and transmitting circuits 445 and 446 and the isolation communication circuit 313 are used to provide the mode indicating signals 402p from the primary control integrated circuit 411 to the secondary control integrated circuit 412, for controlling the secondary control integrated circuit 412 to provide the third secondary switch control signal 333 to control the third secondary switch 325. Therefore, the voltage conversion circuit 320 is controlled to operate in the symmetrical mode or the asymmetrical mode.

The symmetrical mode control circuit 341 is configured to provide the symmetrical mode control signal 304 for controlling the first primary switch 321 and the second primary switch 322. The asymmetrical mode control circuit 342 is configured to provide the asymmetrical mode control signal 306 for controlling the first primary switch 321 and the second primary switch 322. Based on the mode indicating signal 402p, the symmetrical mode control signal 304 or the asymmetrical mode control signal 306 is selected as the primary switch control signal 308 for controlling the first primary switch 321 and the second primary switch 322. As shown in FIG. 4, a selecting circuit 447 is configured to receive the symmetrical mode control signal 304, the asymmetrical mode control signal 306 and the mode indicating signal 402p, and to provide the symmetrical mode control signal 304 or the asymmetrical mode control signal 306 as the primary switch control signal 308 based on the mode indicating signal 402p. It should be appreciated that the selecting circuit 447 shown in FIG. 4 is only for illustration purpose, other circuits that could realize the selection function may be used in the embodiment of the present disclosure.

In the embodiment of FIG. 4, the symmetrical mode control circuit 341 may be implemented by control circuits of the LLC topology circuit. The asymmetrical mode control circuit 342 may be implemented by control circuits of the asymmetrical half-bridge flyback converter topology circuit. The symmetrical mode control circuit 341 and the asymmetrical mode control circuit 342 have been previously illustrated in detail and descriptions thereof are omitted here.

The embodiment of FIG. 4 further includes the driving circuit 314 and the driving circuit 315. The driving circuit 314 is configured to receive the primary switch control signal 308, and to convert the primary switch control signal 308 into the first primary switch control signal 308-1 for controlling the first primary switch 321. The driving circuit 315 is configured to receive the primary switch control signal 308, and to convert the primary switch control signal 308 into the second primary switch control signal 308-2 for controlling the second primary switch 322. In one embodiment, the first primary switch control signal 308-1 has the opposite phase with the second primary switch control signal 308-2, such that the first primary switch 321 is turned on and off alternately with the second primary switch 322.

It should be understood that under the control of the first primary switch control signal 308-1 and the second primary switch control signal 308-2, there is a dead time to avoid the shoot-through of the first primary switch 321 and the second primary switch 322. In other words, there is the time that the first primary switch 321 and the second primary switch 322 are both turned off. In one embodiment, the driving circuit 314 and the driving circuit 315 may be integrated independently in different ICs. In another embodiment, the driving circuit 314 and the driving circuit 315 may be integrated in the same IC. In yet another embodiment, some or all of the driving circuit 314, the driving circuit 315 and the primary control integrated circuit 311 may be integrated in the same IC.

In the embodiment of FIG. 4, the secondary control integrated circuit 412 further includes a secondary control circuit 444. The secondary control circuit 444 is configured to receive the mode indicating signal 402s, and to provide the third secondary switch control signal 333 for controlling the third secondary switch 325 based on the mode indicating signal 402s. In some embodiments, the mode indicating signal 402s is a signal having a high voltage level and a low voltage level, which is directly used as the third secondary switch control signal 333 for controlling the third secondary switch 325.

The secondary control circuit 444 is further configured to provide the secondary switch control signal 331 for controlling the first secondary switch 323 and the second secondary switch 324. In one embodiment, when the third secondary switch 325 is turned on, the voltage conversion circuit 320 operates in the symmetrical mode. Each of the first secondary switch 323 and the second secondary switch 324 is turned on and off with the duty cycle of 50%. At this time, the voltage conversion circuit 320 operates the same as the LLC topology. That is, when the first primary switch 321 is turned on and the second primary switch 322 is turned off, the first secondary switch 323 is turned on and the second secondary switch 324 is turned off; and when the first primary switch 321 is turned off and the second primary switch 322 is turned on, the first secondary switch 323 is turned off and the second secondary switch 324 is turned on. Typically, each of the switches 321-324 is turned on and off with the duty cycle of 50% during one operating period of the voltage conversion circuit 320. In other words, during one operating period of the voltage conversion circuit 320, the on-period of the first primary switch 321 is same as the on-period of the second primary switch 322, and the on-period of the first secondary switch 323 is same as the on-period of the second secondary switch 324.

In one embodiment, the control circuit 410 further includes driving circuits 316 and 317. The driving circuit 316 is configured to generate the first secondary switch control signal 331-1 based on the secondary switch control signal 331. The driving circuit 317 is configured to generate the second secondary switch control signal 331-2 based on the secondary switch control signal 331. The first secondary switch control signal 331-1 has the opposite phase with the second secondary switch control signal 331-2 (i.e., the phase difference between the two is 180°). The first secondary switch control signal 331-1 and the second secondary switch control signal 331-2 are configured to control the first secondary switch 323 and the second secondary switch 324, respectively. In some embodiments, the first secondary switch control signal 331-1 is in phase with the secondary switch control signal 331, and the second secondary switch control signal 331-2 has the opposite phase with the secondary switch control signal 331. In other embodiments, the first secondary switch control signal 331-1 has the opposite phase with the secondary switch control signal 331, and the second secondary switch control signal 331-2 is in phase with the secondary switch control signal 331.

In one embodiment, when the third secondary switch 325 is turned off, the voltage conversion circuit 320 operates in the asymmetrical mode, and the second secondary switch 324 and the second secondary winding 353 are inoperable. The first secondary switch 323 operates under the control of the first secondary switch control signal 331-1. In one embodiment, when the first primary switch 321 is turned on and the second primary switch 322 is turned off, the first secondary switch 323 is turned off; and when the first primary switch 321 is turned off and the second primary switch 322 is turned on, the first secondary switch 323 is turned on. In one embodiment, when the third secondary switch 325 is turned off, the first secondary switch control signal 331-1 is substantially consistent with the secondary switch control signal 331. In one embodiment, the driving circuit 316 and the driving circuit 317 may be integrated independently in different ICs. In another embodiment, the driving circuit 316 and the driving circuit 317 may be integrated in the same IC. In yet another embodiment, some or all of the driving circuit 316, the driving circuit 317 and the secondary control integrated circuit 412 may be integrated in the same IC.

In the embodiment of FIG. 4, the first primary switch 321, the second primary switch 322, the first secondary switch 323, the second secondary switch 324 and the third secondary switch 325 all include N-type MOSFET device. The source S of the first primary switch 321 is coupled to the drain D of the second primary switch 322. The drain D of the first secondary switch 323 is coupled to the first secondary winding 352, and the source S of the first secondary switch 323 is coupled to the secondary ground terminal 309. The drain D of the second secondary switch 324 is coupled to the second secondary winding 353, and the source S of the second secondary switch 324 is coupled to the source S of the third secondary switch 325. The drain D of the third secondary switch 325 is coupled to the secondary ground terminal 309. In the embodiment of FIG. 4, the source S of the second secondary switch 324 is coupled to the source S of the third secondary switch 325 such that the body diode of the second secondary switch 324 is coupled reversely to the third secondary switch 325 to block the current effectively. In other words, the body diodes of the second secondary switch 324 and the third secondary switch 325 are connected in opposite directions. For example, the anode of the body diode of the second secondary switch 324 is coupled to the anode of the body diode of the third secondary switch 325.

In other embodiments, the drain D of the second secondary switch 324 is coupled to the drain D of the third secondary switch 325 such that the cathode of the body diode of the second secondary switch 324 is coupled to the cathode of the body diode of the third secondary switch 325. In some embodiments, the first primary switch 321, the second primary switch 322, the first secondary switch 323, the second secondary switch 324 and the third secondary switch 325 may also include other types of switching devices, such as GaN devices and SiC devices.

In some embodiments, the primary control integrated circuit 411 and the secondary control integrated circuit 412 are different ICs for controlling the primary circuit and the secondary circuit of the voltage conversion circuit 320, respectively. In some embodiments, the primary control integrated circuit 311 and the secondary control integrated circuit 312 may be integrated in the same package to realize the control of the voltage conversion circuit 320.

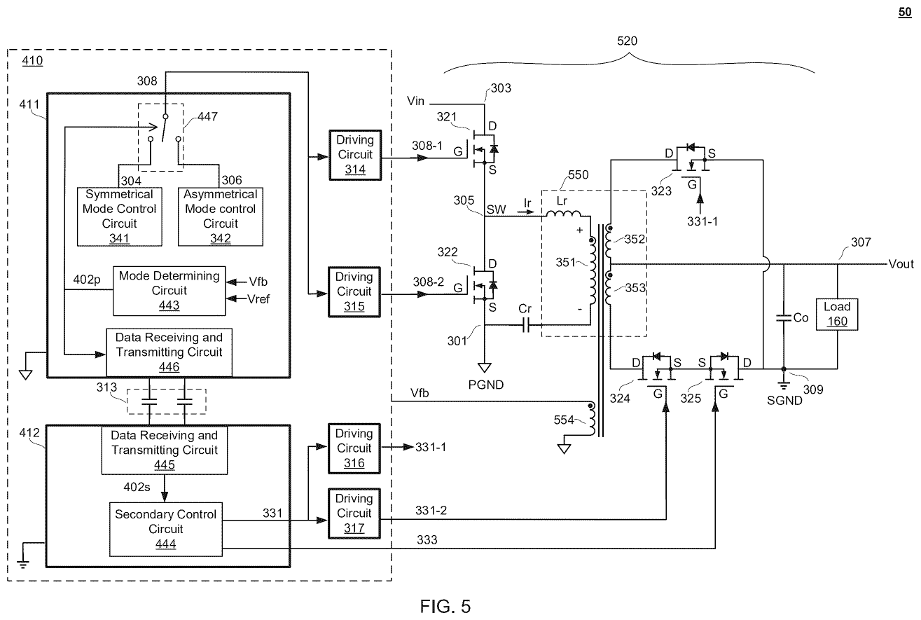

FIG. 5 schematically shows a power system 50 in accordance with one embodiment of the present disclosure. As shown in FIG. 5, the power system 50 includes a voltage conversion circuit 520 and the control circuit 410. The control circuit 410 is configured to receive the feedback signal Vfb indicating the output voltage Vout of the power system 50, and to provide the first primary switch control signal 308-1, the second primary switch control signal 308-2, the first secondary switch control signal 331-1, the second secondary switch control signal 331-2 and the third secondary switch control signal 333 for controlling the voltage conversion circuit 520. The voltage conversion circuit 520 is configured to receive the first primary switch control signal 308-1, the second primary switch control signal 308-2, the first secondary switch control signal 331-1, the second secondary switch control signal 331-2 and the third secondary switch control signal 333, and to convert the input voltage Vin to the output voltage Vout to power the load 160.

In the embodiment of FIG. 5, the third secondary switch 325 is controlled by the third secondary switch control signal 333 based on the output voltage Vout of the power system 50. When the output voltage Vout is greater than the designated value, the third secondary switch 325 is turned on under the control of the third secondary switch control signal 333. When the output voltage Vout is less than the designated value, the third secondary switch 325 is turned off under the control of the third secondary switch control signal 333. When the third secondary switch 325 is turned on, the voltage conversion circuit 520 operates the same as LLC topology. The first secondary switch 323 and the second secondary switch 324 are turned on alternately under the control of the secondary switch control signals 331-1 and 331-2, respectively, such that the energy of the first secondary winding 352 and the second secondary winding 353 is transferred to the load 160. When the third secondary switch 325 is turned off, the voltage conversion circuit 320 operates the same as the asymmetrical half-bridge flyback converter topology. The second secondary winding 353 does not transfer the energy to the load 160. The first secondary switch 323 is turned on and off, such that the energy of the first secondary winding 352 is transferred to the load 160.

Compared with the embodiment of FIG. 4, in the embodiment of FIG. 5, the transformer 550 includes the primary winding 351, the first secondary winding 352, the second secondary winding 353 and an auxiliary winding 554. The auxiliary winding 554 is configured to provide the feedback signal Vfb indicating the output voltage Vout. In other words, the voltage of the auxiliary winding 554 indicates the output voltage Vout, and the feedback signal Vfb is generated based on the voltage of the auxiliary winding 554.

In some embodiments, the ratio between the feedback signal Vfb and the output voltage Vout is determined by the turns ratio of the auxiliary winding 554 to the first secondary winding 352 or the second secondary winding 353. In one embodiment, the feedback signal Vfb is sampled during the first secondary switch 323 is turned on. In this case, the proportional coefficient between the feedback signal Vfb and the output voltage Vout is Vfb:Vout=N554:N352, where N554 represents the number of turns of the auxiliary winding 554, and N352 represents the number of turns of the first secondary winding 352. In one embodiment, the feedback signal Vfb is sampled during the second secondary switch 324 is turned on. In this case, the proportional coefficient between the feedback signal Vfb and the output voltage Vout is Vfb:Vout=N554: N353, where N554 represents the number of turns of the secondary winding 554 and N353 represents the number of turns of the second secondary winding 353. In some embodiments, the value of the feedback signal Vfb may be too large to exceed the input voltage range of the control circuit 410, thus the number of turns of the auxiliary winding 554 could be adjusted to regulate the value of the feedback signal Vfb. In some other embodiments, the feedback signal Vfb may be provided via a voltage dividing circuit. The operating process of the control circuit 410 is described above and will not be described herein.

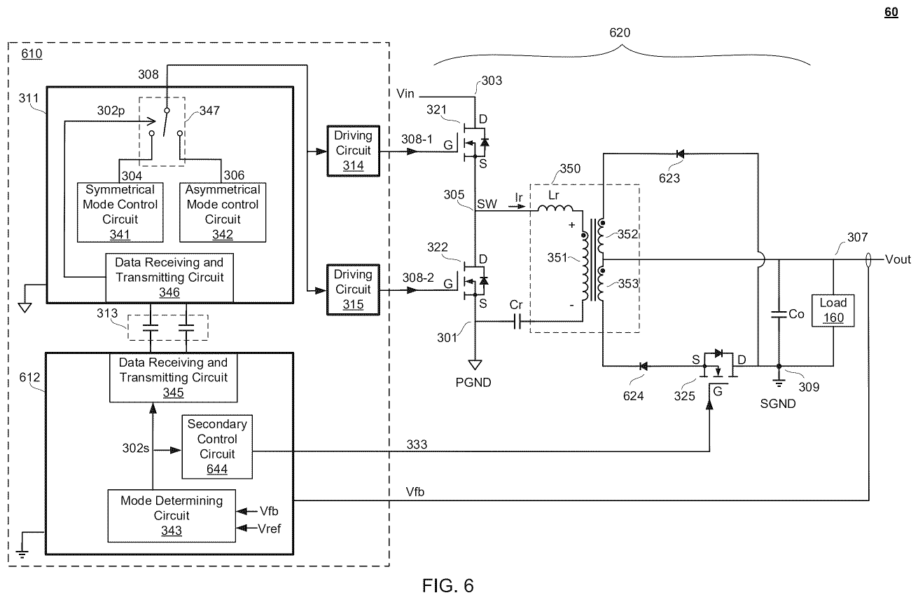

FIG. 6 schematically show a power system 60 in accordance with one embodiment of the present disclosure. As shown in FIG. 6, the power system 60 includes a voltage conversion circuit 620 and a control circuit 610. The control circuit 610 is configured to receive the feedback signal Vfb indicating the output voltage Vout of the power system 60, and to provide the first primary switch control signal 308-1, the second primary switch control signal 308-2 and the third secondary switch control signal 333 for controlling the voltage conversion circuit 620. The voltage conversion circuit 620 is configured to receive the first primary switch control signal 308-1, the second primary switch control signal 308-2 and the third secondary switch control signal 333, and to convert the input voltage Vin into the output voltage Vout to power the load 160.

In the embodiment of FIG. 6, the first primary switch 321, the second primary switch 322 and the third secondary switch 325 are realized by controllable N-type MOSFET devices, and the first secondary switch 623 and the second secondary switch 624 are realized by diodes. When the output voltage Vout is greater than the designated value, the third secondary switch 325 is turned on, the voltage conversion circuit 620 operates the same as the LLC topology. The first secondary switch 623 and the second secondary switch 624 are turned on and off alternately, and the first secondary switch 623 and the second secondary switch 624 are turned on for approximately 50% of the switching period in each switching period of the voltage conversion circuit 620, respectively. When the output voltage Vout is less than the designated value, the third secondary switch 325 is turned off, the voltage conversion circuit 620 operates the same as the asymmetric half-bridge flyback converter topology. The second secondary winding 353 does not transfer the energy to the load 160. The first secondary switch 623 is turned on and off to transfer the energy of the first secondary winding 352 to the load 160. When the first primary switch 321 is turned off and the second primary switch 322 is turned on, the first secondary switch 623 is turned on.

In the embodiment of FIG. 6, the working principles of the symmetrical mode control circuit 341 and the asymmetrical mode control circuit 342 are as illustrated above. A secondary control circuit 644 is configured to provide the third secondary switch control signal 333 for controlling the third secondary switch 325 based on the mode indicating signal 302s. In some embodiments, the secondary control circuit 644 may be omitted, and the mode indicating signal 302s is used directly as the third secondary switch control signal 333 for controlling the third secondary switch 325.

It should be understood that, FIGS. 2-6 only show some embodiments of the present disclosure. The present disclosure may be specifically implemented in various forms without departing from the spirit or essence of the invention. For example, in some embodiments, the secondary control circuits 344, 444, and 644 may be omitted. In some embodiments, the symmetrical mode control circuit 341 and the asymmetrical mode control circuit 342 may be independently integrated in different ICs to provide the symmetrical mode control signal 304 and the asymmetrical mode control signal 306 for controlling the first primary switch 321 and the second primary switch 322. In some embodiments, the circuits shown in the embodiments of FIGS. 2-6 may be integrated in the same IC in any combination and not limited to the embodiments shown in FIGS. 2-6. In the embodiment of FIGS. 2-6, the primary winding 351 of the transformer is coupled in series with the resonant capacitor Cr, and the primary winding 351 and the resonant capacitor Cr are coupled in parallel with the second primary switch 322, which could be referred to low side connection. In other embodiments, the primary winding 351 of the transformer is coupled in series with the resonant capacitor Cr, and the primary winding 351 and the resonant capacitor Cr are coupled in parallel with the first primary switch 321, which could be referred to high side connection. Accordingly, the operating process of the control circuit should be adjusted adaptively.

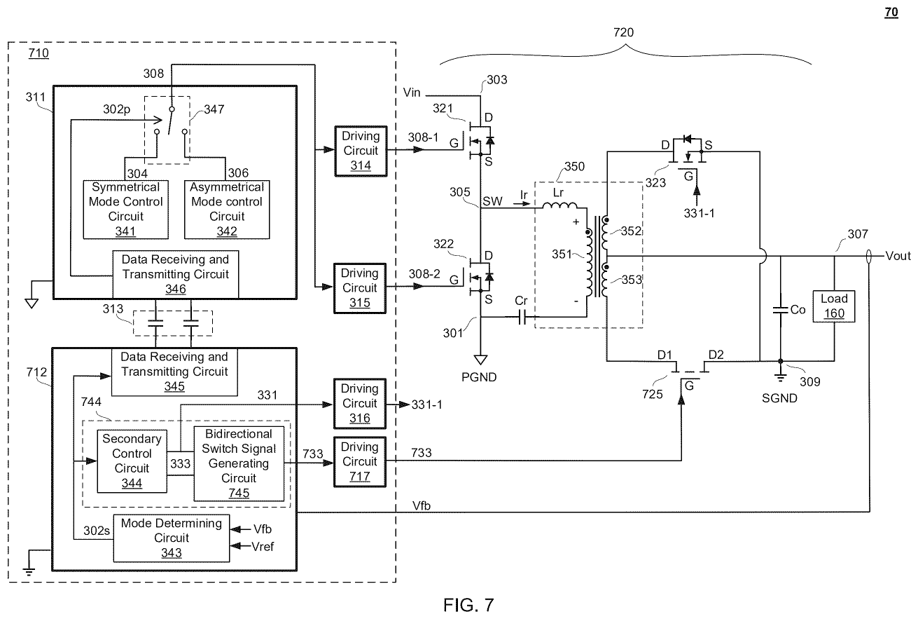

In some embodiments, the second secondary switch and the third secondary switch may be replaced by a bidirectional switch. FIG. 7 schematically shows a power system 70 in accordance with one embodiment of the present disclosure. As shown in FIG. 7, the power system 70 includes a voltage conversion circuit 720 and a control circuit 710. Compared to the voltage conversion circuits in the previous embodiments, the voltage conversion circuit 720 includes a bidirectional switch 725. The bidirectional switch 725 is coupled series with the second secondary winding 353.

In one embodiment, the bidirectional switch 725 is a bidirectional GaN switch. Unlike the MOSFET, the bidirectional GaN switch does not have a body diode. When the control terminal G of the bidirectional GaN switch is driven (e.g., by a high voltage level) to turn on the bidirectional GaN switch, the direction of the current flowing through the bidirectional GaN switch is further determined by the voltages at switching terminals D1 and D2. When the voltage of the control terminal G is greater than the voltage of the switching terminal D1, and the voltage of the switching terminal D1 is greater than the voltage of the switching terminal D2, the current flowing through the bidirectional switch 725 flows from the switching terminal D1 to the switching terminal D2. When the voltage of the control terminal G is greater than the voltage of the switching terminal D2, and the voltage of the switching terminal D2 is greater than the voltage of the switching terminal D1, the current flowing through the bidirectional switch 725 flows from the switching terminal D2 to the switching terminal D1. When the voltage of the switching terminal D1 is equal to the voltage of the switching terminal D2, there is no current flowing through the bidirectional switch 725. When the control terminal G is not driven (e.g., by a low voltage level), the bidirectional switch 725 is turned off.

The control circuit 710 is configured to provide the first secondary switch control signal 331-1 and a bidirectional switch control signal 733 for controlling the first secondary switch 323 and the bidirectional switch 725, respectively. In one embodiment, when the voltage conversion circuit 720 operates in the symmetrical mode (i.e., the voltage conversion circuit 720 operates the same as LLC circuit topology), the first secondary switch control signal 331-1 and the bidirectional switch control signal 733 respectively control the first secondary switch 323 and the bidirectional switch 725 to turn on and off alternately. In some embodiments, the duty cycles of the first secondary switch 323 and the bidirectional switch 725 are approximately to 50%. When the voltage conversion circuit 720 operates in the asymmetrical mode, the bidirectional switch control signal 733 turns off the bidirectional switch 725, and the first secondary switch control signal 331-1 controls the first secondary switch 323 to turn on and off with a suitable duty cycle.

In the embodiment of FIG. 7, the control circuit 710 includes the mode determining circuit 343, the symmetrical mode control circuit 341, the asymmetrical mode control circuit 342 and a secondary control circuit 744. The working principles of the mode determining circuit 343, the symmetrical mode control circuit 341, and the asymmetrical mode control circuit 342 are as illustrated above. In one embodiment, the secondary control circuit 744 includes the secondary control circuit 344 and a bidirectional switch signal generating circuit 745. The secondary control circuit 744 is configured to generate the secondary switch control signal 331 and the bidirectional switch control signal 733 based on the mode indicating signal 302s. The driving circuit 316 is configured to provide the first secondary switch control signal 331-1 to control the first secondary switch 323 based on the secondary switch control signal 331. After the driving capability of the bidirectional switch control signal 733 is enhanced by the driving circuit 717, the bidirectional switch control signal 733 is used to control the bidirectional switch 725.

In one embodiment, when the mode indicating signal 302s indicates that the voltage conversion circuit 720 operates in the symmetrical mode, the bidirectional switch control signal 733 has the opposite phase with the secondary switch control signal 331. In one embodiment, when the mode indicating signal 302s indicates that the voltage conversion circuit 720 operates in the asymmetrical mode, the bidirectional switch control signal 733 is at a low voltage level for turning off the bidirectional switch 725.

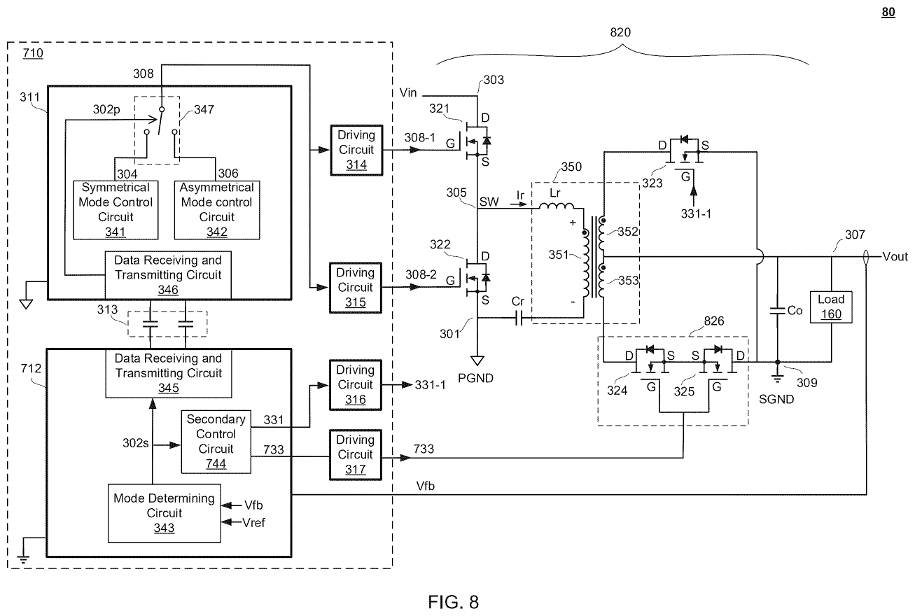

FIG. 8 schematically shows a power system 80 in accordance with one embodiment of the present disclosure. As shown in FIG. 8, the power system 80 includes a voltage conversion circuit 820 and the control circuit 710. Compared to the voltage conversion circuits in the previous embodiments, the voltage conversion circuit 720 includes a bidirectional switch 826. The bidirectional switch 826 is coupled in series with the second secondary winding 353. In the embodiment of FIG. 8, the bidirectional switch 826 includes the second secondary switch 324 and the third secondary switch 325 which are coupled in series. Furthermore, the body diode of the second secondary switch 324 is coupled reversely to the body diode of the third secondary switch 325, and the control terminal of the second secondary switch 324 is coupled to the control terminal of the third secondary switch 325.

The control circuit 710 is configured to provide the first secondary switch control signal 331-1 and the bidirectional switch control signal 733 for controlling the first secondary switch 323 and the bidirectional switch 826, respectively. In one embodiment, when the voltage conversion circuit 820 operates in the symmetrical mode (i.e., the voltage conversion circuit 820 operates the same as the LLC topology), the first secondary switch control signal 331-1 and the bidirectional switch control signal 733 respectively control the first secondary switch 323 and the bidirectional switch 825 to turn on and off alternately. In some embodiments, the duty cycles of the first secondary switch 323 and the bidirectional switch 825 are approximately to 50%. At this time, the bidirectional switch control signal 733 is equivalent to the second secondary switch control signal 331-2 in the embodiment of FIG. 3. When the voltage conversion circuit 820 operates in the asymmetrical mode, the bidirectional switch control signal 733 turns off the bidirectional switch 826, and the first secondary switch control signal 331-1 controls the first secondary switch 323 to turn on and off with the suitable duty cycle.

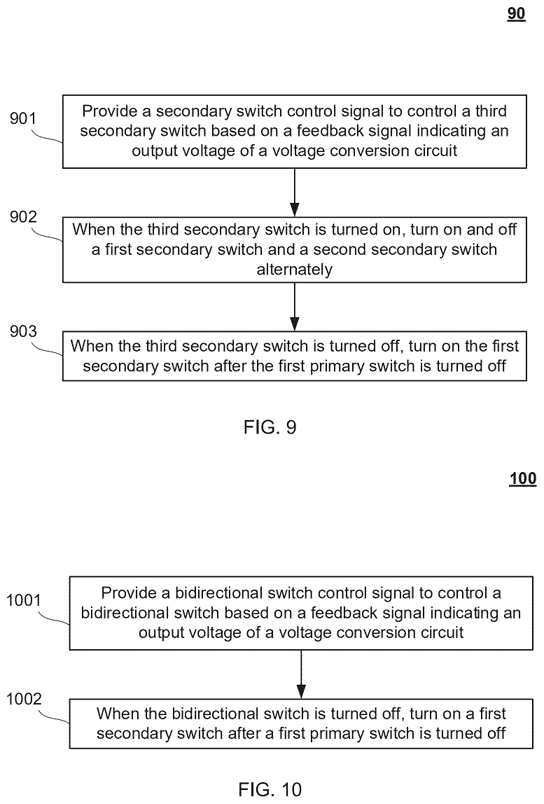

FIG. 9 shows a flowchart of a method 90 for controlling a voltage conversion circuit in accordance with one embodiment of the present disclosure. The voltage conversion circuit includes voltage conversion circuits 320, 520 and 620 in the previous embodiments. Specifically, the voltage conversion circuit includes a transformer, a first primary switch, a second primary switch, a first secondary switch, a second secondary switch and a third secondary switch. The first primary switch and the second primary switch are coupled in series between an input terminal and a primary ground terminal. The first secondary switch is coupled to a first secondary winding of the transformer. The second secondary switch is coupled to a second secondary winding of the transformer. The third secondary switch is coupled in series with the second secondary switch. The method 90 includes an action 901.

In action 901, a secondary switch control signal is provided to control the third secondary switch based on a feedback signal indicating an output voltage of the voltage conversion circuit. When the feedback signal is within a designated voltage range, the third secondary switch is turned on; and when the feedback signal is out of the designated voltage range, the third secondary switch is turned off.

In one embodiment, the method 90 further includes actions 902-903. In action 902, when the third secondary switch is turned on, the first secondary switch and the second secondary switch are turned on and off alternately. In one embodiment, in one switching period, the on-period of the first secondary switch is equal to the on-period the second secondary switch. In action 903, when the third secondary switch is turned off, the first secondary switch is turned on after the first primary switch is turned off. The method 90 illustrated above could be performed in different orders.

FIG. 10 shows a flowchart of a method 100 for controlling a voltage conversion circuit in accordance with one embodiment of the present disclosure. The voltage conversion circuit includes voltage conversion circuits 720 and 820 in the previous embodiments. Specifically, the voltage conversion circuit includes a transformer, a first primary switch, a second primary switch, a first secondary switch and a bidirectional switch. The first primary switch and the second primary switch are coupled in series between an input terminal and a primary ground terminal. The first secondary switch is coupled to a first secondary winding of the transformer. The bidirectional switch is coupled in series with a second secondary winding of the transformer. The method 100 includes an action 1001.

In action 1001, a bidirectional switch control signal is provided to control the bidirectional switch based on a feedback signal indicating an output voltage of the voltage conversion circuit. When the feedback signal is within a designated voltage range, the bidirectional switch is turned on and off alternately with the first secondary switch; and when the feedback signal is out of the designated voltage range, the bidirectional switch is turned off.

In one embodiment, the method 100 further includes an action 1002. In action 1002, when the bidirectional switch is turned off, the first secondary switch is turned on after the first primary switch is turned off.

The method 100 illustrated above could be performed in different orders.

In the present invention, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated, and they obviously will be resorted to by those skilled in the art without departing from the spirit and the scope of the invention as hereinafter defined by the appended claims as only a preferred embodiment(s) thereof has been disclosed.

What is claimed is:

1. A power system, comprising:
a first secondary switch configured to be coupled to a first secondary winding of a transformer;
a second secondary switch configured to be coupled to a second secondary winding of the transformer; and
a third secondary switch coupled in series with the second secondary switch;
wherein the third secondary switch is controlled based on an output voltage of the power system.

2. The power system of claim 1, further comprising:
a first primary switch; and
a second primary switch, wherein the second primary switch and the first primary switch are coupled in series between an input terminal of the power system and a primary ground terminal, and wherein a connection point formed by the first primary switch and the second primary switch is coupled to a primary winding of the transformer.

3. The power system of claim 1, further comprising:
a control circuit configured to, based on a feedback signal indicating the output voltage of the power system, provide a primary switch control signal to control a first primary switch and a second primary switch, provide a secondary switch control signal to control the first secondary switch and the second secondary switch, and provide a third secondary switch control signal to control the third secondary switch.

4. The power system of claim 3, wherein the control circuit comprises:
a mode determining circuit configured to provide a mode indicating signal based on the feedback signal;
a symmetrical mode control circuit configured to provide a symmetrical mode control signal; and
an asymmetrical mode control circuit configured to provide an asymmetrical mode control signal;
wherein the control circuit is configured to provide the symmetrical mode control signal or the asymmetrical mode control signal as the primary switch control signal to control the first primary switch and the second primary switch.

5. The power system of claim 4, further comprising:
an isolation communication circuit;
wherein the symmetrical mode control circuit and the asymmetrical mode control circuit are integrated in a primary control integrated circuit, the mode determining circuit is integrated in a secondary control integrated circuit, and the mode indicating signal is provided from the secondary control integrated circuit to the primary control integrated circuit via the isolation communication circuit.

6. The power system of claim 4, further comprising:
an isolation communication circuit;
wherein the mode determining circuit, the symmetrical mode control circuit and the asymmetrical mode control circuit are integrated in a primary control integrated circuit, and the mode indicating signal is provided from the primary control integrated circuit to a secondary control integrated circuit via the isolation communication circuit.

7. The power system of claim 1, wherein when a feedback signal indicating the output voltage of the power system is within a designated voltage range, the third secondary switch is turned on; and when the feedback signal is out of the designated voltage range, the third secondary switch is turned off.

8. The power system of claim 1, wherein the transformer further has an auxiliary winding, and a feedback signal indicating the output voltage of the power system is generated based on a voltage of the auxiliary winding.

9. The power system of claim 1, wherein the first secondary switch, the second secondary switch and the third secondary switch include Metal-Oxide-Semiconductor Field-Effect Transistors (MOSFETs), and a source of the second secondary switch is coupled to a source of the third secondary switch.

10. The power system of claim 2, wherein:
when the third secondary switch is turned on, the first secondary switch and the second secondary switch are turned on and off alternately; and
when the third secondary switch is turned off, the first secondary switch is turned on after the first primary switch is turned off.

11. The power system of claim 1, wherein a body diode of the second secondary switch is coupled reversely to a body diode of the third secondary switch.

12. The power system of claim 1, wherein the first secondary switch and the second secondary switch include diodes, the third secondary switch includes MOSFET, and the second secondary switch is coupled reversely to a body diode of the third secondary switch.

13. A control circuit for a voltage conversion circuit with a transformer, a first secondary switch coupled to a first secondary winding of the transformer, and a bidirectional switch coupled to a second secondary winding of the transformer, wherein the control circuit comprises:
a mode determining circuit configured to provide a mode indicating signal based on a feedback signal indicating an output voltage of voltage conversion circuit;
wherein the control circuit is configured to provide a bidirectional switch control signal to control the bidirectional switch of the voltage conversion circuit based on the mode indicating signal.

14. The control circuit of claim 13, further comprising:
a symmetrical mode control circuit configured to provide a symmetrical mode control signal; and
an asymmetrical mode control circuit configured to provide an asymmetrical mode control signal;
wherein the control circuit is configured to provide the symmetrical mode control signal or the asymmetrical mode control signal as a primary switch control signal to control a first primary switch and a second primary switch of the voltage conversion circuit.

15. The control circuit of claim 13, further comprising:
a secondary control circuit configured to provide a secondary switch control signal to control the first secondary switch.

16. The control circuit of claim 13, wherein the bidirectional switch of the voltage conversion circuit includes a second secondary switch and a third secondary switch, and the second secondary switch is coupled in series with the third secondary switch.

17. The control circuit of claim 16, wherein a control terminal of the second secondary switch is coupled to a control terminal of the third secondary switch, and a body diode of the second secondary switch is coupled reversely to a body diode of the third secondary switch.

18. The control circuit of claim 16, wherein the control circuit is further configured to, based on the feedback signal indicating the output voltage of the voltage conversion circuit, provide a primary switch control signal to control a first primary switch and a second primary switch of the voltage conversion circuit, and provide a secondary switch control signal to control the first secondary switch.

19. A method for controlling a voltage conversion circuit with a transformer, a first secondary switch coupled to a first secondary winding of the transformer, a second secondary switch coupled to a second secondary winding of the transformer, and a third secondary switch coupled in series with the second secondary switch, the method comprising:
Providing a secondary switch control signal to control the third secondary switch based on a feedback signal indicating an output voltage of the voltage conversion circuit;
wherein when the feedback signal is within a designated voltage range, the third secondary switch is turned on; and when the feedback signal is out of the designated voltage range, the third secondary switch is turned off.

20. The method of claim 19, wherein the voltage conversion circuit further comprises a first primary switch and a second primary switch coupled in series between an input terminal and a primary ground terminal, and wherein the method further comprises:
when the third secondary switch is turned on, turning on and off the first secondary switch and the second secondary switch alternately; and
when the third secondary switch is turned off, turning on the first secondary switch after the first primary switch is turned off.
